(19) United States
(12) Patent Application Publication
(10) Pub. No.: US 2010/0201808 A1
(43) Pub. Date: Aug. 12, 2010

(54) CAMERA BASED MOTION SENSING SYSTEM

(75) Inventor: Feng-Hsiung Hsu, Cupertino, CA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/367,665

(22) Filed: Feb. 9, 2009

(51) Int. Cl. H04N 7/18

(52) U.S. Cl. 348/135; 348/E07.085

(57) ABSTRACT

Providing camera based motion detection is disclosed herein. A camera may track a reference element array of retroreflectors, which reflect light from a light source located proximate the camera. A known arrangement of the reference element array may be compared to a received arrangement on an image sensor of the camera to determine position information of at least one of the camera or the reference element array. The reference elements may include a style (pattern, shape) that may enable extraction of additional position information when the reference element array is captured by the camera. A user-manipulated device may be configured with the camera and light source, or alternatively, the reference elements, to enable communication with a computing device and display device.

### BACKGROUND

Many devices allow a user to control a software application run on a computing device such as a game console or personal computer. The user may manipulate these controller devices to control an on-screen pointer, to control movement and behavior of a game object (e.g., avatar), and so on. In addition, the software application may provide inputs (controls) through the controller device without an onscreen pointer. For example, a motion of a remote control may be detected or otherwise determined for simulation of an on-screen activity such as a sports activity. The most prevalent of such devices include keyboards, mouse devices, joy sticks, trackballs, voice recognition tools, and hand-held remote controls. Other types of control devices include data gloves, inertial sensors, and radio positioning mechanisms.

Among the variety of controller devices, motion-based (or motion-sensitive) remote controllers have gained significant commercial interests recently, especially in the gaming industry. There are two types of motion-based control techniques. The first type uses a motion detection device such as an accelerometer or gyroscopes which can inherently measure its own motion. The second type uses remote sensing techniques to determine the positions of a moving object (such as a hand-held controller used by a user) and then translate the change of the positions to knowledge of the motion of the moving object. The two types of motion-based control techniques may be combined. The present-day motion-based controllers using remote sensing techniques tend to have one or more shortcomings including complicated design, high cost for fabrication, lack of flexibility, bulky size, and poor control accuracy.

### SUMMARY

A camera based motion sensing system may include a camera, light source, and a reference element array. The camera may track the reference element array of retroreflectors, which reflect light back to the camera from the light source that is located proximate the camera. An actual arrangement of the reference element array may be compared to a received arrangement on an image sensor of the camera to determine position information of at least one of the camera or the reference element array. The reference elements may include a style (pattern, shape) that may enable extraction of additional position information when the reference element array is captured by the camera.

In some aspects, a user-manipulated device may be configured with the camera and light source to enable communication with a computing device and display device. Alternatively, the user-manipulated device may be configured with the reference elements. The user-manipulated device may enable a user to interact with an application run by the computing device to control an output of the computing device. The computing device may output an object to a display, whereby the object includes position information resulting from camera based motion sensing.

In other aspects, additional cameras may be used to increase an operational range of the user-manipulated device, which is defined by a collective operational range of each camera. Further, the reference elements may be integrally formed in a display, the user-manipulated device, or within other objects.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows an illustrative system of detecting motion of a camera that is in communication with a computing device in accordance with one or more embodiments of the disclosure.

FIG. 2 shows an illustrative multidirectional movement of a user-manipulated device relative to a display device and a reference element array in accordance with some embodiments of the disclosure.

FIG. 3 shows an illustrative top view illustrating the change of the image arrangement of the reference element array as the camera moves up and down along the z-axis.

FIG. 4 shows an illustrative top view illustrating the change of the image arrangement of the reference element array as the camera moves left and right along the x-axis.

FIG. 5 shows an illustrative top view illustrating the change of the image arrangement of the reference element array as the camera experiences a yaw motion around the z-axis.

FIG. 6 shows an illustrative top view illustrating the change of the image arrangement of the reference element array as the camera experiences a roll motion around the y-axis.

FIG. 7 shows an illustrative left side view illustrating the change of the image arrangement of the reference element array as the camera experiences a pitch motion around the x-axis.

FIG. 8 shows an illustrative system of detecting motion of a reference element array relative to a camera that is in communication with a computing device in accordance with various embodiments of the disclosure.

FIG. 9 shows an illustrative computing device that may be used to implement the illustrative system of FIG. 1 and FIG. 8.

FIG. 10 shows an illustrative process that may be implemented by the systems of FIGS. 1 and 8, or by some other system.

FIG. 11 shows an illustrative user-manipulated device having multiple cameras and a display having integrated retroreflectors in accordance with one or more embodiments of the disclosure.

### DETAILED DESCRIPTION

### Overview

This disclosure sets forth techniques, apparatuses, and systems for controlling a computing device or a software application run by a computing device based on image information obtained from an image sensor such as that of a camera. The disclosure relates to motion-based control of a computing device, such as a personal computer, a game console, a set top box, a television, etc. To accomplish this, an array of reference elements that reflect light (e.g., retroreflectors) is used in conjunction with the camera. An image sensor (e.g., a still camera, a video camera, etc.) captures an image of the reference element array. The array image has an arrangement formed by a nonparallel projection of the reference triangle onto the image sensor. The arrangement carries information of the relative position between the image sensor and the reference element array, and changes as the relative position changes. The position information extracted from the arrangement may express a multidimensional position of the image sensor with respect to multiple axes, including translational axes (x-axis, y-axis, z-axis) and rotational axes (roll, pitch, yaw).

In general, there are at least two techniques for implementing the motion detection. A first technique places the reference element array of retroreflectors near or on a display device connected to the computing device and couples the camera including its image sensor to the user-manipulated device itself (e.g., a remote control device), such that the camera moves with the user-manipulated device. The movable camera captures image information of the reference element array. A position determination module identifies an arrangement of the image of the reference element array in the image information and then computes position information based on the identified arrangement. The position information, in turn, can be used to control the computing device or an application run on the computing device.

A second technique couples the reference element array of retroreflectors to the user-manipulated device. A stationary camera captures image information of the mobile reference element array. The position determination module processes the image information in the manner described above.

### Exemplary System

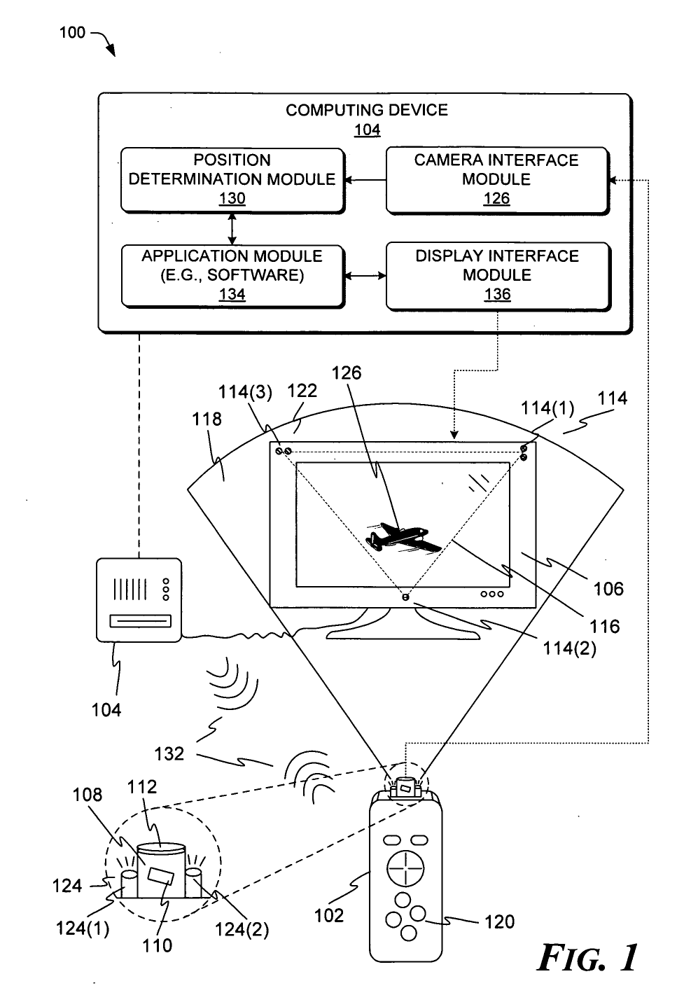

FIG. 1 is a block diagram showing an illustrative system 100 for detecting motion of a camera that is in communication with a computing device in accordance with one or more embodiments of the disclosure. In this system 100, a user manipulates a user-manipulated device 102 to interact with computing device 104 (or an application run on computing device 104) through a display device 106. A camera 108 is attached to user-manipulated device 102 so that the camera 108 and the user-manipulated device 102 are movable together as an assembly. In one embodiment, camera 108 may be an integral part of user-manipulated device 102, although alternative embodiments contemplate the camera 108 and user-manipulated device 102 being separate components. The camera 108 has an image sensor 110 and a lens and filter assembly 112 generally facing display device 106 during operation.

A reference element array 114 is located proximate the display device 106 in the exemplary configuration shown, but may also be placed at another location nearby the display device 106, for instance on top of the display device 106. Reference element array 114 may have various reference elements 114(1), 114(2) and 114(3) that define vertices of a reference arrangement 116 having a shape (e.g., a triangle, polygon, etc.) and are generally visible to camera 108 when the camera 108 is facing the display device 106 within an operational range 118. As will be shown herein, the reference element array 114 is configured to form an array image on the image sensor 110 through a three-dimensional projection of the reference arrangement 116 onto the image sensor 110. The array image has the image of the reference arrangement 116 changing shape as the relative position between the image sensor 110 and reference element array 114 changes.

In some embodiments, as is the featured embodiment of FIG. 1, the three-dimensional projection of the reference element array 114 onto the image sensor 110 is a nonparallel projection, meaning that the object plane defined by the triangle formed by reference elements 114(1), 114(2) and 114(3) is not parallel to the image plane defined by the image sensor 110 when the user-manipulated device 102 is at a normal position and pointing normally to the display device 106. To accomplish this, the reference element array 114 may be placed relative to display device 106 such that the reference arrangement 116 defines a plane substantially nonparallel to the image sensor 110. As will be shown herein, as the image of the reference element array 114 is formed by projecting the reference element array 114 in a three-dimensional space onto the image sensor 110, the configuration enables multidimensional information (stereo information) that is carried by the image of the reference element array 114 to be captured by camera 108.

In other embodiments, the reference arrangement 116 of the reference element array 114 may be parallel to, or close to be parallel to, the surface of image sensor 110. In this configuration, the projection may be reduced to a simple parallel projection which carries less stereo information. However, the latter configuration may be preferable due to aspects such as space constraints of the reference element array 114, aesthetics, or for other reasons.

The user-manipulated device 102 can include any kind of control mechanism, including a remote control device, any kind of game control device, a computer mouse, and so forth. The user-manipulated device 102 may represent a handheld device that the user can move about (with the user's hands) to achieve a desired control operation. Alternatively, the user-manipulated device 102 may represent a device with one or more members that the user can separately move about to achieve a desired control operation. In some embodiments, the user-manipulated device 102 may be a device that is worn by the user, such as a data glove-type device, a wristband-type device, a headband-type or hat-type device, a shoe-borne device, and so forth (or any combination thereof). The user-manipulated device 102 can also include any variety of control actuators 120 (buttons, joysticks, knobs, steering mechanisms, etc.) to provide input commands and other selections.

The reference element array 114 may be placed on or against the display device 106, attached to the display device, integrated with the display device, or otherwise placed in a defined positional relationship (e.g., on a wall, on a floor, etc) with the user-manipulated device 102. To facilitate discussion, the user-manipulated device 102 will be discussed as including three reference elements 114(1), 114(2) and 114(3). However, in other embodiments the reference element array may include only one or two reference elements or more than three reference elements that form the reference arrangement 116 of an arrangement of dots such as vertical dots, horizontal dots, or other dot arrangements, or shapes such as a polygon, multiple triangles, or other shapes.

In various embodiments, the reference elements 114(1), 114(2), and 114(3) are retroreflectors. The retroreflectors reflect light back to an area proximate a source of the light with minimum scattering of light. Thus, a retroreflector may reflect light originating near the camera 108 back to the camera for receipt (image capture) by the image sensor 110.

In accordance with some embodiments, the reference elements 114(1), 114(2) and 114(3) may include retroreflectors that include a style 122. For example, each retroreflector may include a different style. The style 122 may be a distinct dot arrangement such as two vertical dots, two horizontal dots, or other arrangements of dots. An arrangement of dots may be easy to display because they can be discerned with few pixels, such as a single pixel representing each dot. In other embodiments, the style 122 may be a distinct shape, such as, without limitation, a square, triangle, polygon, circle, star, moon, or other shapes. The style 122 may also include patterns, such a pattern of objects (e.g., lines, dots, etc.) and spacing between the objects. A combination of shape and pattern may also be used to create the style 122. As shown in FIG. 1, an illustrative configuration of the reference element array 114 may include (without limitation) the first reference element 114(1) having two vertical dots with a dot pattern, the second reference element 114(2) having a single dot shape with a grid pattern, and the third reference element 114(3) having two horizontal dots with a lined pattern, each defining the style 122 of the respective reference element.

The term “position information” in the implementation of FIG. 1 refers to the position of the camera 108 with the image sensor 110 relative to a point of origin. To help acquire position information and to also help discriminate the reference elements 114(1), 114(2) and 114(3) from other objects, the reference element array 114 can include the reference elements in the reference arrangement 116. In the exemplary embodiment shown in FIG. 1, the reference elements 114(1), 114(2) and 114(3) are arranged as a triangle (as shown by the illustrative dashed lines) from the perspective of the camera 108 pointed substantially perpendicular to the display device 106. Other arrangements may be used, which may include more or fewer reference elements. The inclusion of more reference elements may include a tracking ability of the camera 108 while fewer reference elements may facilitate simple tracking in two-dimensional or three-dimensional space.

In accordance with various embodiments, a light source 124 may be located proximate the camera 108. The light source 124 may be aimed in the same general direction of the camera 108 to emit light on objects that are recorded, via the image sensor 110, by the camera.

The light source 124 may include one or more lights, such as a first light 124(1) and a second light 124(2), although any number of lights may be used. The light source 124 can be each composed of one or more visible-spectrum or non-visible-spectrum (infrared, ultraviolet) light sources, such as light emitting diodes (LEDs) and so forth. In the case of visible spectrum LEDs, one or more primary color LEDs can be used to help distinguish the LEDs from other objects in a scene. Other types of light sources may also be used, which may include, without limitation, incandescent lights, halogen lights, fluorescent lights, carbon arc lights, discharge lights, and so forth.

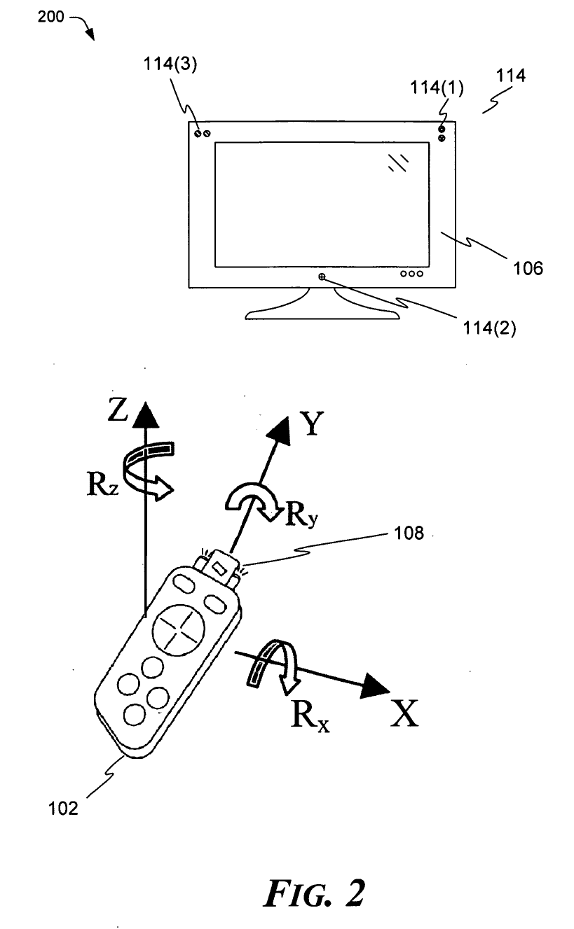

In operation, when the light source 124 is directed at the reference element array 114, the retroreflectors of the reference elements 114(1), 114(2), and 114(3) may reflect light from the light source back to the camera 108 for capture on the image sensor 110. The image sensor 110 may receive the light that is reflected back toward the camera 108 from the reference elements 114(1), 114(2), and 114(3), which may form a received arrangement as will be discussed in more detail in FIGS. 2-7.

In various embodiments, the camera 108 captures image information of the reference element array 114. The image information provides a depiction of the reference elements 114(1), 114(2) and 114(3) (or at least part thereof). To function in this manner, the camera 108 can be positioned so that the operational range 118 (the camera's field of view) encompasses at least part of, and preferably all of, the reference element array 114 when a user is expected to be operating the user-manipulated device 102 to interact with computing device 104 (or an application run by the computing device 104).

The image sensor 110 may be any suitable imaging device that converts a visual image to an electric signal. It may be an array of charge-coupled devices (CCD) or CMOS sensors such as active pixel sensors. The image sensor 110 may be a color image sensor or black and white image sensor, or may be adapted for infrared light. Various color separation mechanisms, including Bayer algorithm, may be used if a color sensor is used.

The camera 108 may be a video camera or a still image camera. However, in order capture rapid action, the camera is preferably capable of capturing multiple images in a series. In some embodiments, the camera may be a video camera capable of capturing at least twenty (20) frames per second each depicting a different successive temporal state. The camera 108 can comprise any kind of commercial or application-specific camera for capturing image information. The camera 108 may optionally include the lens and filter assembly 112 configured to selectively pass electromagnetic radiation having a prescribed frequency. For instance, in the case that the light source 124 is composed of one or more infrared LEDs, the camera 108 can include an infrared filter to help selectively detect the infrared radiation reflected by the reference elements 114(1), 114(2) and 114(3) from the light source.

The computing device 104 can utilize the position information to affect its operation or the operation of software application run by the computing device. For example, the computing device 104 may, via software, use information obtained by the camera 108, to manipulate an object 126 that is outputted on the display device 106. The computing device 104 can include a personal computer, a game console, a set-top box, and so on. FIG. 1 generically represents features of the computing device 104 which are relevant to the processing of the image information. To facilitate explanation, FIG. 1 shows the computing device 104 as being implemented by a single integral unit. However, the computing device 104 can also represent plural units that are communicatively coupled together.

The computing device 104 can include a camera interface module 128. The camera interface module 128 receives image information from the camera 108 and optionally converts this information into a form that allows it to be further processed by the computing device 104. For instance, the camera interface module 128 can optionally convert any aspect of the format of the received image information to any other format. The computing device 104 can implement the camera interface module 128 as a video card or like device which couples to a motherboard (not shown) of the computing device 104.

The computing device 104 also includes a position determination module 130. The purpose of the position determination module 130 is to detect and analyze the image information and generate position information therefrom. The position information reflects the position of the user-manipulated device 102 (and associated the camera 108) in relation to reference elements 114(1), 114(2) and 114(3). As discussed above, the term “position information” refers to the position of the camera 108 with the image sensor 110 relative to a point of origin, such as the reference elements 114(1), 114(2) and 114(3), the display device 106, an object being presented on the display device, etc. The term “position information” can also describe the orientation of the camera 108 relative to the point of origin.

To this function, the position determination module 130 can first receive information of an image of the reference element array from the image sensor 110, identify the arrangement of the array image, and then generate position information based on the identified arrangement of the array image. The position information expresses the relative position between the image sensor 110 and the reference element array 114. In some embodiments, because the camera 108 with its image sensor 110 is attached to the user-manipulated device 102, the position information also expresses the relative position between the user-manipulated device 102 and the reference element array 114.

The position determination module 130 can detect the reference elements 114(1), 114(2) and 114(3) in various ways. For example, this can be accomplished by analyzing the pixel content of the image information received. In one technique, the reference elements 114(1), 114(2) and 114(3) may have visual characteristics which are distinguishable from other objects in the image information. For instance, suppose that the reference elements emit infrared radiation. In this implementation, the camera 108 (equipped with an infrared filter) can produce image information having bright spots against a darkened background, where the bright spots represent the reference elements. In another case, suppose that the reference elements emit primary color light. In this implementation, the camera 108 can produce image information having bright primary-colored spots which can be distinguished from other objects in the scene (which typically do not have the same kind of monotonic primary color characteristics). These reference elements can even more readily be detected by placing them against a darkened background to create a high contrast environment. For example, the high contrast environment may be created by placing the reference elements on a black plate that may be a part of the reference element array 114 (a position guide, etc.) or part of the display device 106.

The camera interface module 128 may receive the image information from the camera 108 via a transmission 132, such as by a wireless transmission (e.g., Bluetooth, WiFi, etc.) or by other communication routes such as a wired connection. Alternatively, the position determination module 130 may be implemented in user-manipulated device 102 to obtain position information and subsequently deliver or transmit the position transmission to computing device 104.

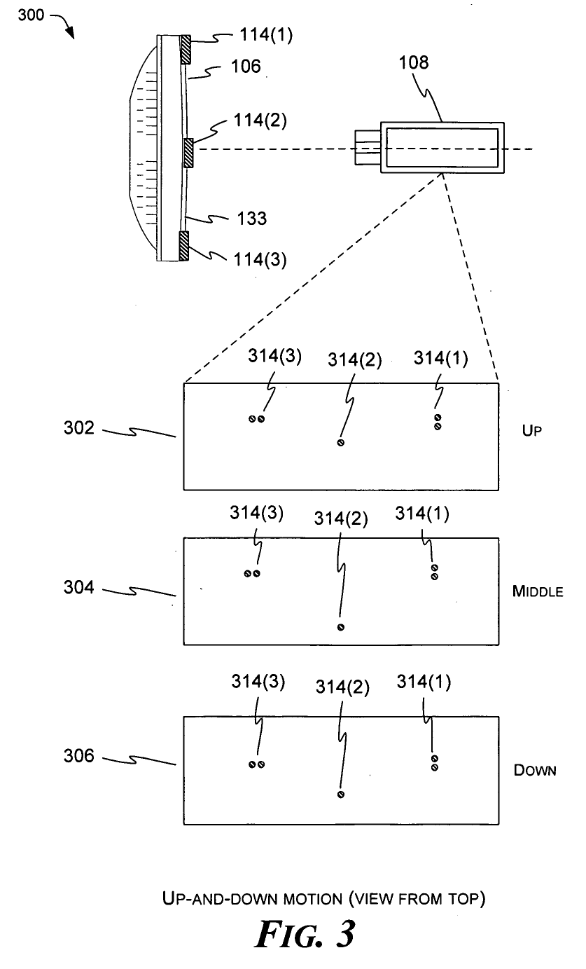

The image of the reference element array 114 captured by camera 108 generally has an image of each reference element 114(1), 114(2) and 114(3), as will be discussed in further detail herein with reference to FIGS. 3-7. If the camera 108 is a digital camera, each reference element image may be a bright spot made of multiple pixels. In this case, the position determination module 130 may be configured to identify the arrangement of the array image by clustering the multiple pixels of each reference element image to a separate group. For example, minimal spanning tree algorithm may be used to cluster the infrared points captured by the camera into three groups, where each group has multiple infrared points together forming a collective bright spot representing an image of one of the reference elements 114(1), 114(2) and 114(3). The algorithm may further take the brightness as weight, calculating the weighted barycenter of these groups of points. With image sensor of 640×480 pixels, for example, approximately two thousands points per frame may be allocated for the three brought spots representing images of reference elements 114(1), 114(2) and 114(3). This ensures that arrangement recognition mechanism using minimal spanning tree algorithm is efficient and accurate.

In various embodiments, the camera 108 takes approximately 20 or more shots per second. This rate is generally sufficient to capture position information with ordinary speed of user movement. In this scenario, the position of the each light spot (bright spot corresponding to reference element 114(1), 114(2) or 114(3)) will not change significantly within the two consecutive frames. Given the pre-knowledge of the shape and position of the reference element array 114, the position determination module 130 may be able to identify which light spot correspond to which of the reference elements 114(1), 114(2) and 114(3), although absolute identity may not be necessary to track changes. The position determination module 130 may label the light spots at the initial frame and the track them in the following frames in real time. The position determination module 130 can also distinguish the reference elements 114(1), 114(2) and 114(3) from each other based on a telltale prearrangement of between the reference elements 114(1), 114(2) and 114(3). For example, this function can be performed by comparing an arrangement of candidate reference elements with predetermined and pre-stored arrangements. If the arrangement of elements in the image information matches one of the predetermined arrangements, then the position determination module 130 can conclude that a bona fide reference array has been detected in the image information. Alternatively, each reference element 114(1), 114(2) and 114(3) may be differentiated by their distinctive colors, sizes or brightness. In some implementations, the position information may be adequately generated using less than 20 frames per second, such as to track the position of a slow moving object over a relatively longer period of time measured in minutes, hours, or days.

The output of the position determination module 130 is reference information that reflects the presence of a captured image of the reference array 114. The position determination module 130 next converts the determined reference information into position information.

The task of converting reference information into position information varies depending on numerous environment-specific factors. For example, because the image of the reference element array has a known arrangement, the arrangement carries information of the relative position between the image sensor and the reference element array, and changes as the relative position changes. A geometric method may be used to approximate the position and orientation of the user-manipulated device 102. The position information extracted from the arrangement may express a multidimensional position of the image sensor with respect to multiple axes. As described in further detail herein, the position and orientation may be described using a six-axis system which expresses a multi-axis position of the user-manipulated device with respect to three axes (x-axis, y-axis and z-axis) describing a translational position, and three rotational axes describing a pitch motion, a roll motion, and a yaw motion.

In one case, this transformation can be expressed by one or more geometrical mapping equations. The mapping equations can take into consideration any one or more of: the position of the reference elements with respect to one or more fixed reference points; the position of the reference elements with respect to each other (not only the distances but also the geometric shape); the movement of the images of the reference elements (when compared between frames shot at different times), and so on. The equations can include various correction factors to account for the distortion produced by the camera 108, as well as other potential considerations. A calibration procedure can be use to calibrate the positioning determination module 130, and to thereby facilitate determination of various such correction factors.

Generally, with one triangular set of the reference elements 114(1), 114(2) and 114(3), the position determination module 130 can track the positions and orientations, with respect to six axes including both the three-dimensional location and three-dimensional orientation, of the user-manipulated device 102. The use of additional reference elements further enhances the amount of positioning detail or accuracy that can be extracted from the reference information, and in some cases may also avoid “blind spots.” Further, the use of additional cameras 108 may increase the operational range 118 or create a second operational range that is separate from a first operation range.

The position information generated from the image information can be supplemented by other input, e.g., as obtained from the other input device(s). One such other input device that can be used is any kind of inertial sensor or combination of inertial sensors, such as accelerometers and gyroscopes. As well known, inertial sensors provide positioning information that is relative in nature. For example, an inertial sensor can provide position information that indicates that the user has moved the user-manipulated device 102 up five inches at a particular rate. The position determination module 130 can use this kind of supplemental position information to help validate the accuracy of position information obtained via the image information. In other instances, there are times when the camera 108 cannot “see” the reference elements 114(1), 114(2) and 114(3). In this case, the positioning information obtained from the inertial sensor(s) (or other supplemental input device) can be used to overcome the “blind spots” in the image information of the camera 108.

The position determination module 130 may transmit its generated position information to an application module 134. The application module 134 represents any kind of application that can perform any prescribed set of functions. For instance, the application module 134 can represent a simulation application (such as a flight simulator application to control the object 126), a game application of any variety, an Internet navigation application, and so on. In any event, the application module 134 uses the position information to control its behavior. The specific nature of this control depends on the nature of the application module 134 itself. For instance, some applications are conventionally controlled by a computer mouse or a keyboard. For these applications, the determined the position information may be used to generate mouse or keyboard input for various operations in the application.

The application module 134 can provide any kind of output which reflects the outcome of its control behavior. For example, the application module 134 can generate a visual output of the object 126 via a display interface module 136. The display interface module 136 presents the visual output on the display device 106. The display device 106 may be a television set of any kind, a computer monitor of any kind, and so on.

In FIG. 1, the system 100 is shown to have position determination module 130 residing with the computing device 104. However, it is appreciated that this module may either be a separate unit connected to computing device 104, or a unit implemented within user-manipulated device 102. With the miniaturization of modern processes, is feasible to have a position determination module 130 built into even a compact user manipulation device 102. Furthermore, transmitting positional information may take less bandwidth than transmitting image information, which may be a consideration if the user-manipulated device 102 communicates with the computing device 104 wirelessly. However, where multiple user-manipulated devices 102 are used for controlling a single computing device 104, it may be less costly to build a centralized position determination module 130 in the computing device 104 instead of in each user-manipulated device 102.

### Illustrative Operation

Various specific exemplary scenarios are presented in FIGS. 2-7 to facilitate understanding of the nature of the control affected by the system 100. In one application, the application module 134 displays some kind of marker projected on the display device 106, such as a pointer or a cursor. For example, the marker can be equivalent of mouse cursor that may be useful to complete an activity via a button displayed on the display device 106. A user can move the marker to a different location on the projection of the display device 106 by pointing to the different location on the display screen with the user-manipulated device 102. To perform this task, it is first assumed the camera 108 can “see” the reference elements 114(1), 114(2) and 114(3) during the above-described movement. The position determination module 130 may extract reference information from the image information produced by the camera 108, and then convert the reference information to position information. The application module 134 uses the position information to adjust the position of the marker on the projection of the display device 106. This can be performed by mapping the position information to an on-screen position using one or more mapping equations. The on-screen position reflects an object that the user is pointing to using the user-manipulated device 102.

In another application, the marker may be an indicator of an aim targeting an object displayed on the display device 106. For example, the application module 134 may present an object to aim at in a shooter-type game. The user can aim at the object by pointing the user-manipulated device 102 at the object. The position determination module 130 and the application module 134 work in the way described above to translate the physical movements of the user-manipulated device 102 to corresponding movement of the on-screen field of focus of the user's weapon. In either the first or second applications, the user can perform supplemental actions with the user-manipulated device 102, such as by selecting a particular object that is being pointed to, shooting a particular object, and so on. In another case, the user may use the above-described techniques to aim at and control some other object that is not necessarily displayed by a displayed device, such as stereo equipment, an appliance, etc.

The above two examples are applicable to the case in which the user points to an object using the user-manipulated device 102. However, in other applications, the user can use the user-manipulated device 102 to achieve other kinds of control. For example, the user can make a characteristic gesture using the user-manipulated device 102 (such as by waving the user-manipulated device 102 in a predetermined manner). The position determination module 130 in conjunction with the application module 134 can recognize the gesture by comparing video captured by the camera 108 with predetermined arrangements. The application module 134 can execute a control operation based on the type of gesture made by the user, as identified by the position information.

In another exemplary case, a game application may “watch” the movements of the user by tracking the position of the reference elements 114(1), 114(2) and 114(3) in the manner described above, and then providing appropriate control based on the user's movement. For instance, a shooting game may attempt to virtually fire at the user based on the user's movements. Here, the user is not attempting to fire upon an on-screen object, but is attempting to avoid being fired upon.

In another exemplary case, an application can monitor the movements of the user in the manner described above. The application can provide an on-screen character or other object that mimics the movements of the user. Still other applications of the system 100 are possible.

FIG. 2 illustrates the multidirectional movement of the user-manipulated device 102 relative to the display device 106 and the reference element array 114 including reference elements 114(1), 114(2) and 114(3). The user-manipulated device 102 is placed opposite to the display device 106 and the reference element array 114. As shown in FIG. 2, the first aspect of the position of the user-manipulated device 102 is described by the three axes (x-axis, y-axis and z-axis). The change of this position relates to a three-dimensional displacement or translational motion (left-and-right along the x-axis, back-and-forth along the y-axis, and up-and-down along the z-axis). The second aspect of the position of the user-manipulated device 102 relates to orientation and is described by three rotational axes, namely Rx rotational axis describing a pitch motion, Ry rotational axis describing a roll motion, and Rz rotational axis describing a yaw motion. The camera 108 captures an image of the reference element array 114. As will be shown with reference to FIGS. 3-7, the image has an arrangement that changes with these motions.

FIG. 3 shows a top view 300 illustrating the change of a known arrangement of the reference element array 114 as the camera 108 moves up and down along the z-axis. As the camera 108 (which may be affixed to the user-manipulated device 102 as shown in FIG. 1) moves up, a camera view 302 shows three reference element reflections 314(1), 314(2) and 314(3), corresponding to the reference elements 114(1), 114(2) and 114(3), respectively. Each reflection 314(1), 314(2) and 314(3) is an image of the respective reference element 114(1), 114(2) and 114(3). These three images (reflections 314(1), 314(2) and 314(3)) form a triangular arrangement. As the camera 108 is at a level position with the reference element array 114, a camera view 304 shows the reflections 314(1), 314(2) and 314(3) with a greater dispersion. As the camera 108 moves, a camera view 306 shows the reflections 314(1), 314(2) and 314(3) again compressed similar to the camera view 302. One may appreciate that the different views 302, 304, and 306 may capture different perspectives of the reflections 314(1), 314(2) and 314(3), which each may include a unique style (e.g., arrangement of dots or shape), such the camera view 302 is distinguishable from the camera view 306.

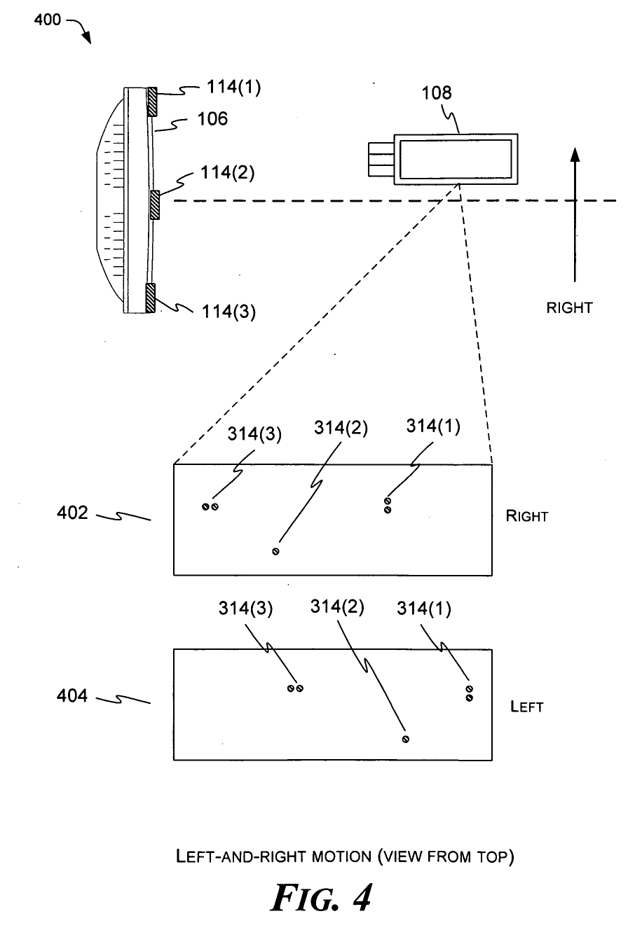

FIG. 4 shows a top view 400 illustrating the change of the image arrangement of the reference element array 114 as the camera 108 moves left and right along the x-axis. A camera view 402 is when the camera 108 (along with the user-manipulated device 102) moves to the right side, showing a non-equilateral triangle arrangement of the reflections 314(1), 314(2) and 314(3). The triangle as a whole shifts to the left side of camera view 402. A camera view 404 reflects the camera 108 movement to the left side, showing a non-equilateral triangle arrangement of the reflections 314(1), 314(2) and 314(3). The two horizontal dots 314(1) in camera view 404 is a mirror image of that in camera view 402, and as a whole shifts to the right side of camera view 402.

When the camera 108 moves back and forth along y-axis in relation to the display device 106, the change of the image arrangement (not shown) depends on the relative position of the camera 108 in the other two dimensions (x-axis and z-axis). For example, if the camera 108 is aligned with the center of the reference element array 114 with respect to x-axis and z-axis, moving the camera 108 along the y-axis only changes the size of the triangle arrangement of reflections 314(1), 314(2) and 314(3) and does not affect the shape thereof.

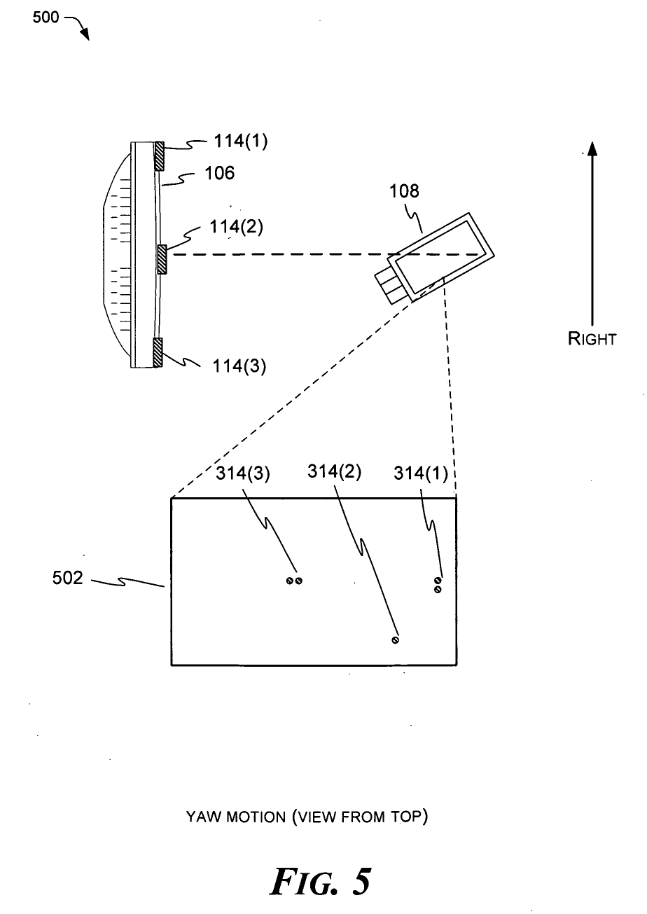

FIG. 5 shows a top view 500 illustrating the change of the image arrangement of the reference element array 114 as the camera 108 experiences a yaw motion around the z-axis. Camera view 502 reflects movement of the camera 108 yawing to the left side, showing a non-equilateral triangle arrangement of the reflections 314(1), 314(2) and 314(3). The triangle as a whole shifts to the right side of camera view 502. When the camera 108 yaws to the opposite direction, the change of the image arrangement will show a mirror image of that in camera view 502, and the image arrangement as a whole shifts to the left side of camera view 502.

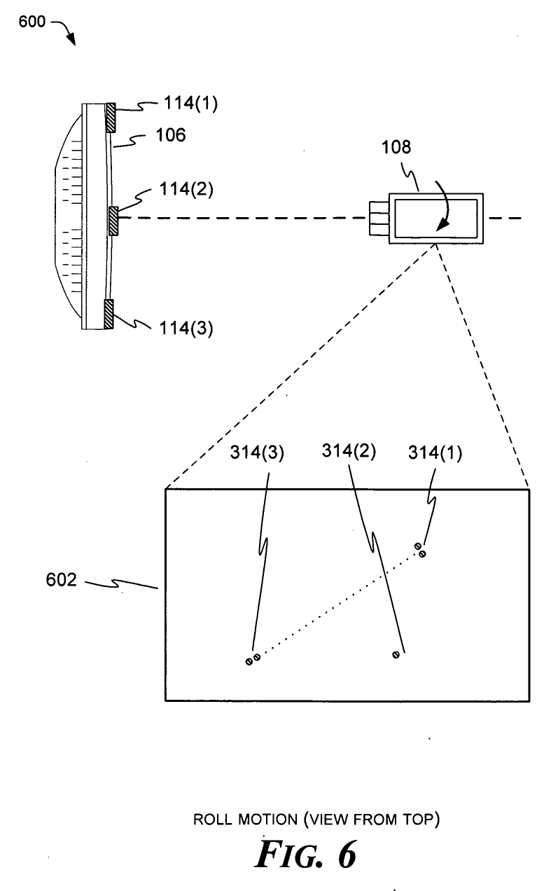

FIG. 6 shows a top view 600 illustrating the change of the image arrangement of the reference element array 114 as the camera 108 experiences a roll motion around the y-axis. Camera view 602 reflects movement of the camera 108 rolling to the left side, showing a skewed triangle arrangement of the reflections 314(1), 314(2) and 314(3). When the camera 108 rolls to the opposite direction, the image arrangement will show similar triangle skewed to the opposite direction.

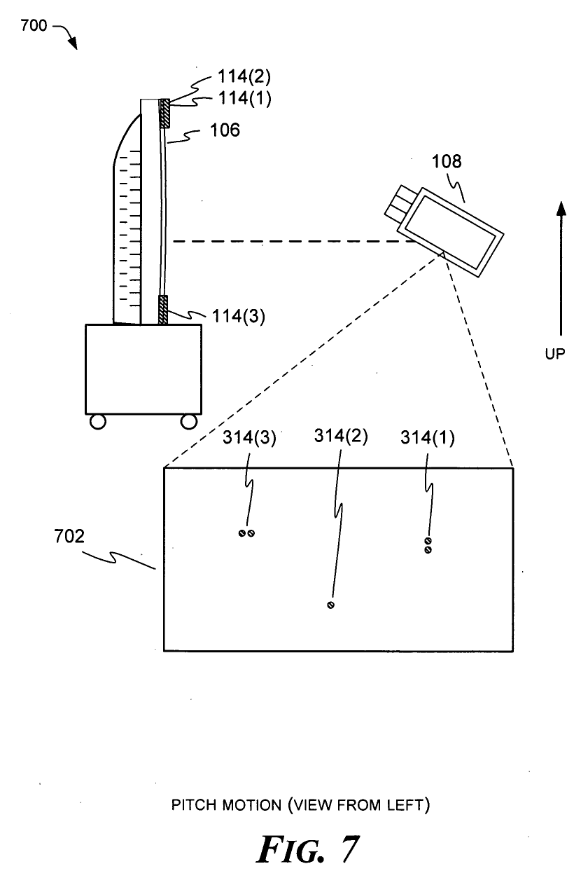

FIG. 7 shows a left side view 700 illustrating the change of the image arrangement of the reference element array 114 as the camera 108 experiences a pitch motion around the x-axis. Camera view 702 reflects movement of the camera 108 pitching to the upper side, showing a triangle arrangement of the reflections 314(1), 314(2) and 314(3).

The exemplary changes of the image arrangement of the reference element array 114 in the camera 108 illustrated above in FIGS. 3-7 show how the image arrangement change relates to the various motions of the camera 108 (along with the user-manipulated device 102) with respect to the six axes. The image of the reference element array 114 is a result of projecting the triangle formed by the three reference elements 114(1), 114(2) and 114(3) through a three-dimensional space onto image sensor 110. The projection also goes through an optical path of the optics (lens) of the camera 108. A geometric relationship between the change of the arrangement shape and the change of position and orientation of the user-manipulated device 102 can be established in order for the position determination module 130 to determine position information from the image information. The above motion-based arrangement changes are described for the purpose of illustration only, and should not be construed as a limitation to the claims attached to this description.

### Illustrative Stationary Camera

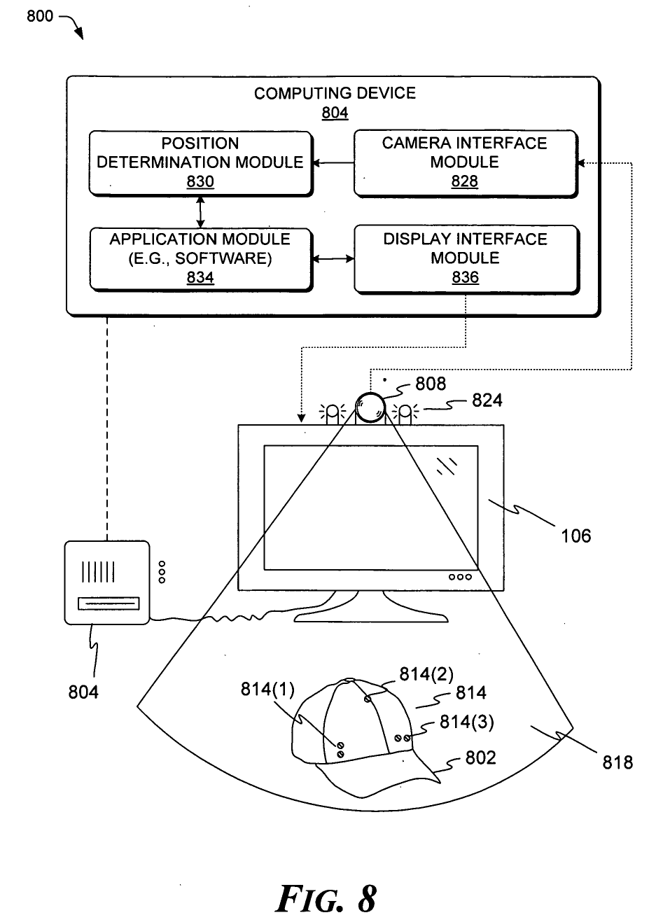

FIG. 8 shows a second implementation for controlling a computing device 804 or an application run by the computing device based on image information obtained from a camera 808. FIG. 8 describes a system 800 in which a user-manipulated device 802 and the camera 808 are separated and placed opposing each other. In some embodiments, the camera 808 is located proximate the display device 106. As described with reference to FIG. 1, a light source 824 is located proximate the camera. A reference element array 814, including reference elements 814(1), 814(2), and 814(3), are coupled to user-manipulated device 802, however, more or fewer reference elements may be used in the system 800. The reference elements 814(1), 814(2), and 814(3) are retroreflectors that reflect light from the light source 824 back to the camera 808 located proximate the light source.

Similar to that illustrated in FIG. 1, the reference elements of reference element array 814 may be arranged to form a known arrangement (shape) and may be located on the user-manipulated device 802. In some embodiments, when only simple tracking motion (e.g., two-dimensional translation motion, etc.) is desired, a single reference element may suffice as the reference element array 814.

In various embodiments, the user-manipulated device 802 may include reference elements arranged around the user-manipulated device, such as to provide camera visibility to a reference element for all, or a portion of the 360 degrees around of the user manipulated device 802. In an example implementation, different (and distinguishable) reference elements may be placed around a wearable version of the user-manipulated device 802 (e.g., a hat, headband, etc.) such that the camera 808 can track a user's movement, via the reference elements, even when some of the reference elements are not visible to the camera (reference elements located on the opposite side of the user-manipulated device relative to the camera). In such embodiments, the camera 108 may be able to differentiate between the reference elements, such as based on the style of the reference element, and thus determine position information of the user-manipulated device even though some of the reference elements are not visible by the camera (not within the operational range 818).

Similar to the first type implementation in FIG. 1, the system 800 has a camera interface module 828 interfacing between the camera 808 and a position determination module 830, and a display interface module 836 interfacing between display device 830 and an application module 834.

Despite the opposite arrangement as compared to the implementation in FIG. 1, the system in the second type implementation works in a similar manner. One difference is that usually there is limited space on user-manipulated device 802 and as a result the size of the known arrangement (e.g., triangle or other shape) formed by the reference element array 814 may be much smaller than its counterpart afforded by reference element array 114 in the first type implementation shown in FIG. 1. For this reason, higher precision may be needed for position determination in the second type implementation.

The system 800 may be applied to various scenarios as described in relation to system 100 of FIG. 1.

### Illustrative Computing Architecture

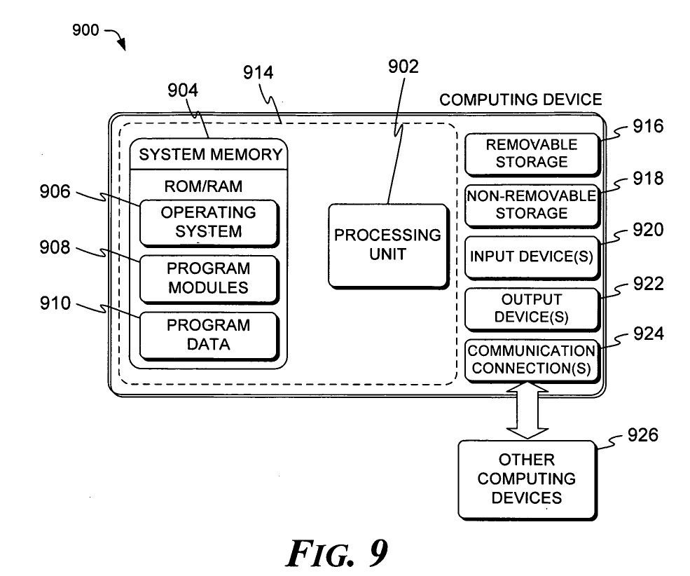

FIG. 9 shows an illustrative computing device 900 that may be used to implement the camera based motion sensing system described herein. It will readily be appreciated that the various embodiments of the motion sensing system and mechanisms may be implemented in other computing devices, systems, and environments, and some portions of the system may be disparately located but in communication, via wired or wireless connectivity. For example, with reference to FIG. 1, some portions of the system may reside in the user-manipulated device 102 while other portions may reside in the computing device 104. The computing device 900 shown in FIG. 9 is only one example of a computing device and is not intended to suggest any limitation as to the scope of use or functionality of the computer and network architectures. The computing device 900 is not intended to be interpreted as having any dependency or requirement relating to any one or combination of components illustrated in the example computing device.

In a very basic configuration, the computing device 900 typically includes at least one processing unit 902 and system memory 904. Depending on the exact configuration and type of computing device, the system memory 904 may be volatile (such as RAM), non-volatile (such as ROM, flash memory, etc.) or some combination of the two. The system memory 904 typically includes an operating system 906, one or more program modules 908, and may include program data 910. The computing device 900 is of a very basic configuration demarcated by a dashed line 914. Again, a terminal may have fewer components but will interact with a computing device that may have such a basic configuration.

The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 916 and non-removable storage 918. Computer storage media may include volatile and nonvolatile, removable and non-removable media implemented in any method or technology for storage of information, such as computer readable instructions, data structures, program modules, or other data. The system memory 904, the removable storage 916, and the non-removable storage 918 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 900. Any such computer storage media may be part of the computing device 900. The computing device 900 may also have input device(s) 920 such as the user-manipulated device 102, 802 of FIGS. 1 and 8, a keyboard, a mouse, a pen, a voice input device, a touch input device, etc. Output device(s) 922 such as the display device 106 of FIG. 1, speakers, a printer, etc. may also be included.

The computing device 900 may also contain communication connections 924 that allow the device to communicate with other computing devices 926, or portions thereof (e.g., the user-manipulated device 102, 802), such as via a network. These networks may include wired networks as well as wireless networks (e.g., Bluetooth, Wi-Fi, etc.). The communication connections 924 are one example of communication media. The communication media may typically be embodied by computer readable instructions, data structures, program modules, etc.

It is appreciated that the illustrated computing device 900 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like. For example, some or all of the components of the computing device 900 may be implemented in a cloud computing environment, such that resources and/or services are made available via a computer network for selective use by client devices.

### Exemplary Process

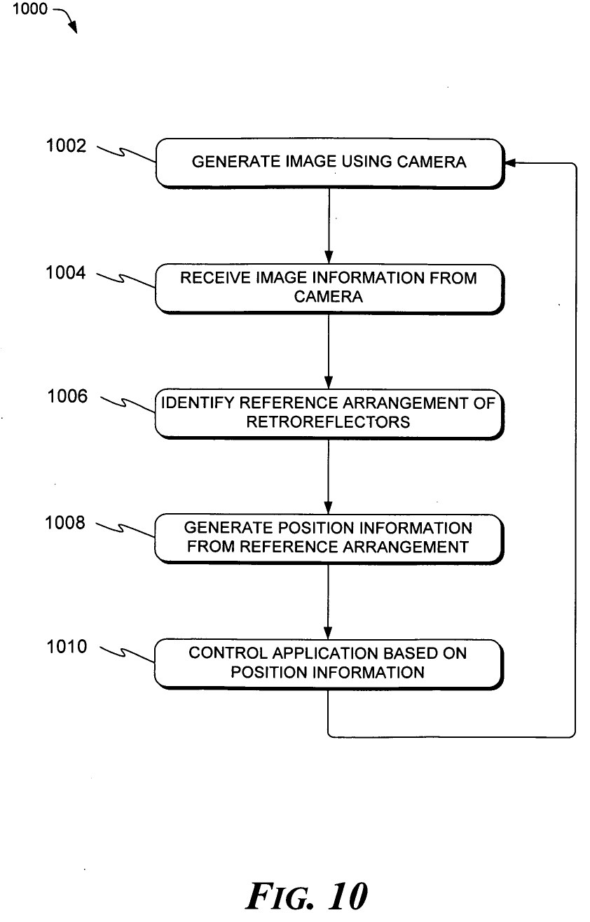

FIG. 10 shows an overview of one exemplary procedure 1000 that can be implemented by the systems (100, 800) of FIGS. 1 and 8, or by some other system. To facilitate discussion, certain operations are described as constituting distinct steps performed in a certain order. Such implementations are exemplary and non-limiting. Certain operations can be grouped together and performed in a single operation, and certain operations can be performed in an order that differs from the order employed in the examples set forth in this disclosure. Since the nature of the operations performed in the procedure 1000 have already been described with reference to FIG. 1, this description serves primarily as a summary of those operations. The process 1000 is generic in that it may be performed with the system of FIG. 1 or FIG. 8.

At 1002, the camera (108, 808) generates an image of the reference element array (114, 814) on image sensor (110, 814). The reference element images have an arrangement formed by projecting the reference element array (e.g., a triangle shaped arrangement, polygon shaped arrangement, etc.) through a three-dimensional space onto the image sensor.

At 1004, the computing device (104, 804) receives image information from the camera (108, 808). According to block 1002, in the first implementation, the image information is obtained in response to the user pointing user-manipulated device 102 at some object on the display device 106 or some other object that is not necessarily displayed on the display device (or performing some other action using the user-manipulated device 102, 802). When the user-manipulated device 102 includes the camera 108 coupled thereto, the reference element array 114 is placed proximate the display device 106 and is viewable by the camera 108. Alternatively, the image information is obtained in response to the user pointing the user-manipulated device 802 at the display screen 106 or some other object that is not necessarily displayed on the display device (or performing some other action using the user-manipulated device 802). The user-manipulated device 802 includes reference element array 814 coupled thereto which is viewable (at least partially) by the camera 808 placed proximate the display device 830.

At 1006, the position determination module (130, 830) identifies a reference arrangement of the retroreflectors in the image information.

At 1010, the position determination module (130, 830) generates position information based on the identified reference arrangement.

At 1012, the application module (134, 834) affects a control based on the position information provided by the position determination module (130, 830). Such control may, in one instance, involve determining what object the user is pointing at using the user-manipulated device (102, 802).

### Exemplary Process

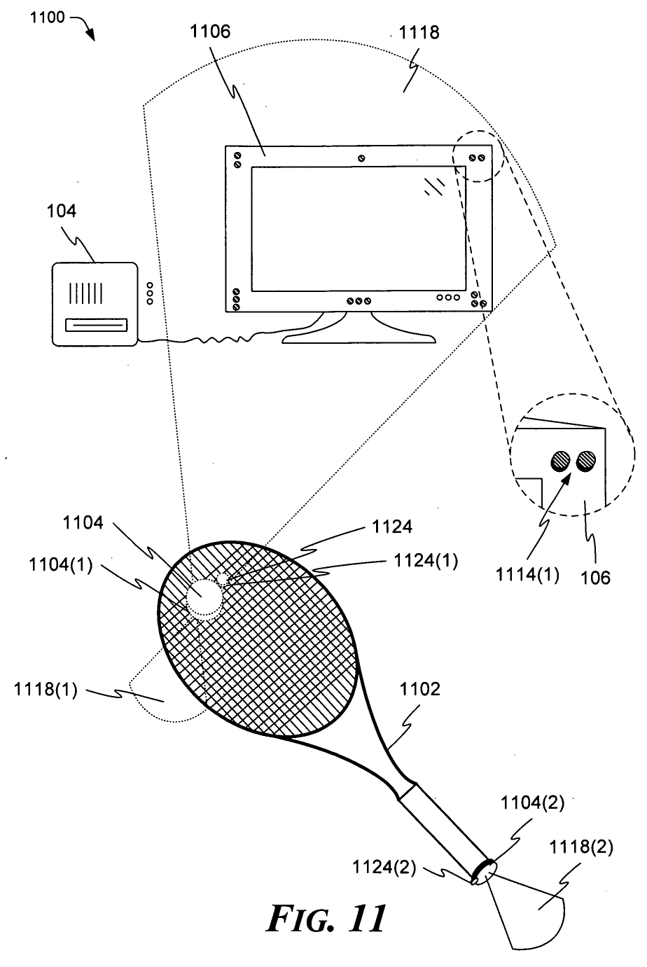

FIG. 11 shows an illustrative environment 1100 having a user-manipulated device 1102 with multiple cameras and a display device 1106 having integrated retroreflectors in accordance with one or more embodiments of the disclosure. The user-manipulated device 1102 may be similar to the user-manipulated device 102 of FIG. 1, except for the addition of one or more additional cameras. The user-manipulated device 1102 may be particularly useful in situations where rotational motion of the user-manipulated device is greater than an operational range provided by a single camera. For example when the user-manipulated device 1102 rotates greater than 180 degrees, an additional camera may be necessary to detect a reference element array 1114. In some embodiments, the user-manipulated device 1102 may be in the shape of an identifiable apparatus, such as a racket, bat, wand, etc, which may control a complimentary virtual object that may be generated by software and projected on the display device 1106.

As shown in FIG. 11, the user-manipulated device 1102 includes a first camera 1104 that includes a first operation range 1118 and a first light source 1124 proximate the first camera. Other cameras may be included in the user-manipulated device 1102, such as a second camera 1082 and a third camera 1084, having operational ranges 1118(1), 1118(2), and proximate light sources 1124(1), 1124(2), respectively. More or fewer cameras and light sources may be included, which ultimately enable increasing the operational range by adding the operational ranges 1118, 1118(1), and 1118(2) to create an effective operational range. In this way, when the user-manipulated device is rotated such that the operation range 1118 of the first camera 1104 does not include the reference element array 1114, then the second camera 1104(1) and/or the third camera 1104(2) may include an operation range 1118(1), 1118(2) that includes the operational range. The position determination module 130, of FIG. 1, may determine the position based on which camera detects the reference element array in accordance with the techniques discussed above.

It is also contemplated that a system similar to that described with reference to FIG. 8 may be implemented that includes additional cameras that are dispersed in an environment where the cameras are stationary and the reference elements change position. Such an implementation may provide similar operation as the environment 1100.

In still another embodiment, a single camera may be modified to include additional operational ranges by including mirrors or other redirectors that change the angle of the operation view. As such, the image sensor, such as the image sensor 110 of FIG. 1, may include a portion dedicated to the first operation range 1118 and a portion dedicated to the second operational range 1118(1), and so forth to simulate the inclusion of additional cameras.

Another embodiment, which may be included with an embodiment having multiple cameras or in another embodiment, may include integrated reference elements. For example, a reference element 1114(1) may be integrated in the display device 106. In some embodiments, the reference element 1101, and other reference elements that are included in a reference element array may be integrated in the display device 106, the computing device 104 (FIG. 1), the user-manipulated device 102, 802, 1102, a wall, or another object, in accordance with an established specification such that the arrangement of the reference elements of the reference element array is know.

### Conclusion

The above description pertains to a camera based motion sensing system. Although the techniques, systems, and apparatus have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. A system for controlling a computing device, the system comprising:
a light emitting device;
a reference element array including at least one retroreflector, the at least one retroreflector configured to reflect light from the light emitting device back toward an area proximate light emitting device;
a camera located in the area proximate the light emitting device, the camera having an image sensor configured to form an array image upon detection of the reflected light from the reference element array, the array image having a detected arrangement that changes shape in accordance with a change in a relative position between the image sensor and the reference element array; and
a position determination module configured to receive the detected arrangement of the array image, and to generate position information based on the detected arrangement of the array image, the position information to express the relative position between the image sensor and the reference element array.

2. The system as recited in claim 1, wherein the camera is a video camera that is integrally formed in a user-manipulated device used for controlling the computing device.

3. The system as recited in claim 1, wherein the reference element array includes at least three retroreflectors.

4. The system as recited in claim 3, wherein the reference element array is located proximate a display that is connected to the computing device, the retroreflectors spaced along a side of the display to substantially span the side of the display, the reference element array positioned such that the retroreflectors are within a line-of-sight of the image sensor.

5. The system as recited in claim 3, wherein the position determination module is configured to generate position information using geometric relations based on a projection of a reference arrangement through a three-dimensional space onto the image sensor to form the array image.

6. The system as recited in claim 3, wherein the position determination module is configured to generate position information capable of expressing a multi-axis position of the image sensor with respect to the reference elements array along three axes (x-axis, y-axis and z-axis) that describe a translational position.

7. The system as recited in claim 6, wherein the position determination module is configured to generate position information capable of expressing a multi-axis position of the image sensor with respect to the reference elements array that further includes a first rotational axis that describes a pitch motion, a second rotational axis that describes a roll motion, and a third rotational axis that describes a yaw motion.

8. The system as recited in claim 1, wherein the light emitting source emits non-visible light that is redirected from the image source via the at least one retroreflector and detectable by the image source.

9. The system as recited in claim 1, wherein the image sensor is located proximate a display and the reference element array is movably located proximate a user, the display in connection with the computing device and configured to output a graphical representation of the position information.

10. The system as recited in claim 1, wherein the position determination module is configured to track the position of the user-manipulated device in real-time.

11. The system as recited in claim 1, wherein the position determination module receives information of the array image from the image sensor via a wireless transmission.

12. The system as recited in claim 1, wherein the at least one retroreflector include a style that is distinct from any other retroreflector, the style being detected by the array image and used by the position determination module to generate the position information based on a known configuration of the at least one retroreflector.

13. The system as recited in claim 1, wherein the computing device comprises a game console.

14. A method of determining relative position information between objects, the method comprising:
transmitting light from a light source directed toward a retroreflector array, the retroreflector array including at least three retroreflectors with a known spatial arrangement;
receiving an image of the retroreflector array by capturing light that is redirected from each of the retroreflectors toward the light source, the image including a perceived arrangement of the retroreflectors that changes as the relative position changes between the retroreflectors and the light source; and
converting the perceived arrangement into position information based on a known spatial arrangement of the retroreflector array, the position information to express the relative position between the retroreflector array and the light source.

15. The method as recited in claim 14, wherein the position information includes multi-axis information along three translational axes (x-axis, y-axis and z-axis) that describe a translational position and three rotation axes (roll, pitch, yaw) that describe a the rotational motion.

16. The method as recited in claim 14, wherein converting the perceived arrangement into position information includes:
detecting a style associated with each retroreflector;
identifying the retroreflector based on the style to create a style arrangement, and
comparing the style arrangement to the known special arrangement of the retroreflector array to determine the relative position between the retroreflector array and the light source.

17. The method as recited in claim 14, wherein at least one of the retroreflector or light source is located proximate a user-manipulated device used to transmit commands to a computing device to manipulate data represented via a graphical display.

18. A positioning system comprising:
a user-manipulated device having a camera and a proximately located light source that is configured to emit light within a visible range of the camera;
an array of retroreflectors that are configured to reflect light from the light source back toward the camera, each retroreflector to form a reference image recorded by the camera when the camera is activated and at least partially facing the retroreflectors, the reference image to form a detected arrangement that varies as the user-manipulated device changes position in relation to a known arrangement of the array; and
a position determination module configured to receive the detected arrangement of the reference image, and generate position information based on the detected arrangement of the reference image, the position information to express the relative position between the user-manipulated device and the retroreflector array.

19. The system as recited in claim 18, further comprising a display configured to output a graphical representation of the position information, and wherein the retroreflectors are integrally formed with the display.

20. The system as recited in claim 18, wherein the retroreflectors have a known unique style, the unique style being detectable in the array image and used by the position determination module to generate the position information based on a known configuration of the retroreflectors.
